(19) United States
(12) Patent Application Publication
(10) Pub. No.: US 2017/0208341 A1
(43) Pub. Date: Jul. 20, 2017

(54) SYSTEM AND METHOD OF MOTION ESTIMATION FOR VIDEO CODING

(71) Applicant: INTEL CORPORATION, Santa Clara, CA (US)

(72) Inventors: Leonid KULAKOV, Moscow (RU); Nikolai SHOSTAK, Krasnogorsk (RU); Pavel S KOVAL, Moscow (RU); Nikolay Kolya SHLYAKHOV, Togliatti (RU)

(21) Appl. No.: 15/326,455

(22) PCT Filed: Aug. 12, 2014
(86) PCT No.: PCT/IB2014/001982

§ 371 Date: Jan. 13, 2017

(51) Int. Cl. H04N 19/533; H04N 19/56; H04N 19/573

(52) U.S. Cl. CPC H04N 19/533; H04N 19/573; H04N 19/56

(57) ABSTRACT

Techniques related to motion estimation for video coding.

### BACKGROUND

Due to ever increasing video resolutions, and rising expectations for high quality video images, a high demand exists for efficient image data compression of video while performance is 5 limited for coding with existing video coding standards such as H.264 or H.265/HEVC (High Efficiency Video Coding) standard. The aforementioned standards use expanded forms of traditional approaches to address the insufficient compression/quality problem, but the results are still insufficient.

These video coding processes use inter-prediction at an encoder to reduce temporal (frame- 10 to-frame) redundancy. Motion estimation is a key operation in an encoder. Motion estimation is the process of finding areas of a frame being encoded that are most similar to areas of a reference frame in order to find the motion vectors. Motion vectors are used to construct predictions for the encoded block. The difference between the prediction and real (original) data is called residual data and is compressed and encoded together with the motion vectors.

By the conventional block-matching full search, a block on a current frame is compared to each block position of a search window on a reference frame. The lowest sum of absolute difference (SAD), mean square error (MSE), or other metric is considered a best match. While very accurate, the full search reduces performance. Instead, fast motion estimation often has two stages with a first stage that starts searching around a most expected motion vector with a 20 minimal step, and uses incremental steps for more distant locations. It is a first search pattern arrangement with many spaces between examined matching block locations. It is faster but with less accurate results. In a refinement step, more points around the best found matching point from the first search pattern arrangement are then checked for the best match. At the refinement stage, the pattern arrangement is similar to that used in the first stage. The farther the best matching 25 point is from a center of the arrangement, the wider is the pattern. Such a process may still have a limited search range and does not sufficiently cover positions in the refinement pass.

### BRIEF DESCRIPTION OF THE DRAWINGS

The material described herein is illustrated by way of example and not by way of limitation in the accompanying figures. For simplicity and clarity of illustration, elements illustrated in the 5 figures are not necessarily drawn to scale. For example, the dimensions of some elements may be exaggerated relative to other elements for clarity. Furthermore, where considered appropriate, reference labels have been repeated among the figures to indicate corresponding or analogous elements. In the figures:

FIG. 1 is an illustrative diagram of an encoder for a video coding system;

FIG. 2 is an illustrative diagram of a decoder for a video coding system;

FIG. 3 is a flow chart showing a motion estimation process for video coding;

FIGS. 4-5 are schematic diagrams showing example search pattern arrangements for a motion estimation process;

FIGS. 6-9 are schematic diagrams showing example search pattern arrangements for 15 another motion estimation process;

FIG. 6A is a schematic diagram to explain an example search pattern arrangement used by the implementations herein.

FIGS. 10A-10B is a detailed flow chart showing a motion estimation process;

FIG. 11 is an illustrative diagram of an example system in operation for providing a motion 20 estimation process;

FIG. 12 is an illustrative diagram of an example system;

FIG. 13 is an illustrative diagram of another example system; and

FIG. 14 illustrates another example device, all arranged in accordance with at least some implementations of the present disclosure.

### DETAILED DESCRIPTION

One or more implementations are now described with reference to the enclosed figures. While specific configurations and arrangements are discussed, it should be understood that this is done for illustrative purposes only. Persons skilled in the relevant art will recognize that other 5 configurations and arrangements may be employed without departing from the spirit and scope of the description. It will be apparent to those skilled in the relevant art that techniques and/or arrangements described herein may also be employed in a variety of other systems and applications other than what is described herein.

While the following description sets forth various implementations that may be manifested in architectures such as system-on-a-chip (SoC) architectures for example, implementation of the techniques and/or arrangements described herein are not restricted to particular architectures and/or computing systems and may be implemented by any architecture and/or computing system for similar purposes. For instance, various architectures employing, for example, multiple integrated circuit (IC) chips and/or packages, and/or various computing devices and/or consumer electronic (CE) devices such as set top boxes, smart phones, etc., may implement the techniques and/or arrangements described herein. Furthermore, while the following description may set forth numerous specific details such as logic implementations, types and interrelationships of system components, logic partitioning/integration choices, etc., claimed subject matter may be practiced without such specific details. In other instances, some material such as, for example, control structures and full software instruction sequences, may not be shown in detail in order not to obscure the material disclosed herein.

The material disclosed herein may be implemented in hardware, firmware, software, or any combination thereof. The material disclosed herein may also be implemented as instructions stored on a machine-readable medium, which may be read and executed by one or more 25 processors. A machine-readable medium may include any medium and/or mechanism for storing or transmitting information in a form readable by a machine (e.g., a computing device). For example, a machine-readable medium may include read only memory (ROM); random access memory (RAM); magnetic disk storage media; optical storage media; flash memory devices; electrical, optical, acoustical or other forms of propagated signals (e.g., carrier waves, infrared 30 signals, digital signals, etc.), and others. In another form, a non-transitory article, such as a non-transitory computer readable medium, may be used with any of the examples mentioned above or other examples except that it does not include a transitory signal per se. It does include those elements other than a signal per se that may hold data temporarily in a “transitory” fashion such as RAM and so forth.

References in the specification to “one implementation”, “an implementation”, “an example implementation”, etc., indicate that the implementation described may include a particular 5 feature, structure, or characteristic, but every implementation may not necessarily include the particular feature, structure, or characteristic. Moreover, such phrases are not necessarily referring to the same implementation. Furthermore, when a particular feature, structure, or characteristic is described in connection with an implementation, it is submitted that it is within the knowledge of one skilled in the art to effect such feature, structure, or characteristic in 10 connection with other implementations whether or not explicitly described herein.

Systems, articles, and methods are described below related to motion estimation for video coding.

As mentioned above, one way to improve video coding is by increasing the speed of motion of estimation. During inter-prediction at an encoder, motion estimation is applied to find 15 the best match between an area of a frame such as a block or sub-block that is being encoded in part of a current frame and a similar block in a reference frame. A motion vector (MV) is the difference of spatial coordinates of the block being encoded (the current block) and the block in the reference frame being examined. The spatial coordinates of the block may be the center of the block, upper-left corner of the block, or other designated pixel location-based point on the block. 20 With this process, the motion vectors, and the small difference between the blocks just mentioned, are encoded instead of encoding the pixel data of an entire frame. The motion estimation is applied in a way to find the closest or best match (or match that is most sufficient) to minimize the cost of the matching process, and strike the right balance between prediction accuracy to provide a high quality picture compression and reduction in delay and lags in the 25 streaming or transmission speed of the compressed video. The cost is usually computed as a combination of a measure of the mismatch between the current block and the reference block, and the amount of bits used to encode the motion vectors.

Fast motion estimation searching is performed to reduce the amount of time needed to find the best block matches, and in turn to find best motion vectors, as well as reduce the bit cost. 30 This is performed by using a search pattern arrangement with patterns to be superimposed on a reference frame. Each pattern has a number of spaced candidate matching block location (MBL) points, such that not every block location will be checked to determine whether it provides the best matching block location. Many of the patterns are square, diamond or other shapes that extend around a center point, and the search pattern arrangement may have different patterns with different shapes and/or a number of the same patterns scaled to different distances from the 5 center referred to as a step. Often times, a logarithmic arrangement is used such that the step for each pattern as it is located farther from the center is determined by using a multiplier (such as 2) to set the scales for the patterns in the arrangement.

One such fast, log motion estimation search pattern is a test zone (TZ) search algorithm that provides relatively good matching with a small number of iterations. The TZ search is often used by video encoders based on H.264 or HEVC (H.265) coding standards. The TZ search uses a two pass logarithmic search with an initial or first stage search to find a first best motion vector. Then in a refinement stage, the search pattern is performed around (including in some other cases, centered at) the best matching block location point so far, and the candidate matching block location points on the patterns of the refinement search pattern arrangement are checked to determine a final best motion vector. The patterns in the refinement search pattern arrangement are checked by testing from the closest pattern to the center of the pattern arrangement and increase the step to move outward through the patterns during the search. With the TZ search, however, many possible matching position are not examined when the positions are outside the given limiting search range or not covered by the second refinement pass. When the best point (or matching block location) is relatively far from the center of the refinement search arrangement, no refinement points around that point are checked. Thus, the best match may be missed.

To resolve these issues, the presently disclosed implementations use a search process that shifts the center point of the refinement search pattern arrangement during logarithmic 25 refinement to the candidate matching block location point with better cost, and then repeats the iteration without decreasing the step. The center is shifted after all current pattern locations are examined, and when a better location is found. By one form, the process on the shifted refinement search pattern arrangement starts at the pattern with the same step as the step that included the best matching block location point before the shift and that is now at the center of 30 the shifted arrangement. Also, once the candidate points on that outer or best step are tested, then the step is reduced so that patterns increasingly closer to the center of the arrangement are tested as the process proceeds. The step is decreased when a pattern does not have a better MBL point than what was already found. If a better point (or in other words a better motion vector) is found, then the center is shifted. This configuration provides the possibility for any possible position to be found as the best matching point providing a significant advantage while encoding in a scene with fast or complex motion. While the center-point shift process herein may add 3-5 block 5 matching computations, these calculations do not decrease the performance by more than approximately 1%. It also provides about 0.1 dB, and more, peak signal to noise ratio (PSNR) improvement for video streams with complex or fast motion.

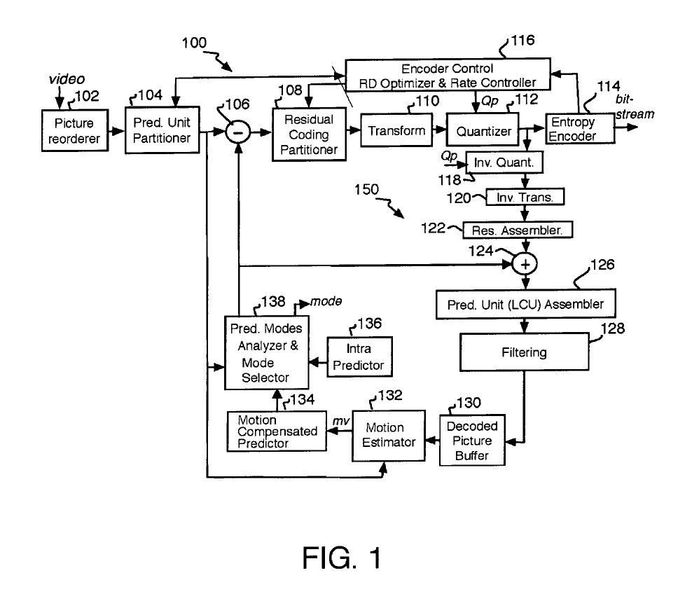

Now in more detail and while referring to FIG. 1, an example video coding system 100 is arranged with at least some implementations of the present disclosure to perform center-shifting 10 motion estimation. In various implementations, video coding system 100 may be configured to undertake video coding and/or implement video codecs according to one or more standards. Further, in various forms, video coding system 100 may be implemented as part of an image processor, video processor, and/or media processor and undertakes inter-prediction, intra-prediction, predictive coding, and residual prediction. In various implementations, system 100 15 may undertake video compression and decompression and/or implement video codecs according to one or more standards or specifications, such as, for example, H.264 (MPEG-4), H.265 (High Efficiency Video Coding or HEVC), and others. Although system 100 and/or other systems, schemes or processes may be described herein, the present disclosure is not necessarily always limited to any particular video encoding standard or specification or 20 extensions thereof.

As used herein, the term “coder” may refer to an encoder and/or a decoder. Similarly, as used herein, the term “coding” may refer to encoding via an encoder and/or decoding via a decoder. A coder, encoder, or decoder may have components of both an encoder and decoder.

In some examples, video coding system 100 may include additional items that have not 25 been shown in FIG. 1 for the sake of clarity. For example, video coding system 100 may include a processor, a radio frequency-type (RF) transceiver, splitter and/or multiplexor, a display, and/or an antenna. Further, video coding system 100 may include additional items such as a speaker, a microphone, an accelerometer, memory, a router, network interface logic, and so forth.

For the example video coding system 100, the system may be an encoder where current 30 video information in the form of data related to a sequence of video frames may be received for compression. The system 100 may partition each frame into smaller more manageable units, and then compare the frames to compute a prediction. If a difference or residual is determined between an original block and prediction, that resulting residual is transformed and quantized, and then entropy encoded and transmitted in a bitstream out to decoders or storage. To perform these operations, the system 100 may include an input picture buffer (with optional picture 5 reorderer) 102, a prediction unit partitioner 104, a subtraction unit 106, a residual partitioner 108, a transform unit 110, a quantizer 112, an entropy encoder 114, and a rate distortion optimizer (RDO) and/or rate controller 116 communicating and/or managing the different units. The controller 116 manages many aspects of encoding including rate distortion or scene characteristics based locally adaptive selection of right motion partition sizes, right coding 10 partition size, best choice of prediction reference types, and best selection of modes as well as managing overall bitrate in case bitrate control is enabled.

The output of the quantizer 112 may also be provided to a decoding loop 150 provided at the encoder to generate the same reference or reconstructed blocks, frames, or other units as would be generated at the decoder. Thus, the decoding loop 150 uses inverse quantization and 15 inverse transform units 118 and 120 to reconstruct the frames, and residual assembler 122, adder 124, and prediction unit assembler 126 to reconstruct the units used within each frame. The decoding loop 150 then provides filters 128 to increase the quality of the reconstructed images to better match the corresponding original frame. This may include a deblocking filter, a sample adaptive offset (SAO) filter, and a quality restoration (QR) filter. The decoding loop 150 also 20 may have a decoded picture buffer 130 to hold reference frames. The encoder 100 also has a motion estimation module or unit 132 that provides motion vectors as referred to below, a motion compensation module 134 that uses the motion vectors, and an intra-frame prediction module 136. Both the motion compensation module 134 and intra-frame prediction module 136 may provide predictions to a selector 138 that selects the best prediction mode for a particular block. 25 As shown in FIG. 1, the prediction output of the selector 138 in the form of a prediction block is then provided both to the subtraction unit 106 to generate a residual, and in the decoding loop to the adder 124 to add the prediction to the residual from the inverse transform to reconstruct a frame. A PU assembler (not shown) may be provided at the output of the Prediction mode analyzer and selector before providing the blocks to the adder 124 and subtractor 106.

More specifically, the video data in the form of frames of pixel data may be provided to the input picture buffer 102. The buffer 102 holds frames in an input video sequence order, and the frames may be retrieved from the buffer in the order in which they need to be coded. For example, backward reference frames are coded before the frame for which they are a reference but are displayed after it. The input picture buffer may also assign frames a classification such as I-frame (intra-coded), P-frame (inter-coded, predicted from a previous reference frames), and B-frame (inter-coded frame which can be bi-directionally predicted from a previous frames, subsequent 5 frames, or both). In each case, an entire frame may be classified the same or may have slices classified differently (thus, an I-frame may include only I slices, P-frame can include I and P slices, and so forth. In I slices, spatial prediction is used, and in one form, only from data in the frame itself. In P slices, temporal (rather than spatial) prediction may be undertaken by estimating motion between frames. In B slices, and for HEVC, two motion vectors, representing 10 two motion estimates per partition unit (PU) (explained below) may be used for temporal prediction or motion estimation. In other words, for example, a B slice may be predicted from slices on frames from either the past, the future, or both relative to the B slice. In addition, motion may be estimated from multiple pictures occurring either in the past or in the future with regard to display order. In various implementations, motion may be estimated at the various 15 coding unit (CU) or PU levels corresponding to the sizes mentioned below. For older standards, macroblocks or other block basis may be the partitioning unit that is used.

Specifically, when an HEVC standard is being used, the prediction partitioner unit 104 may divide the frames into prediction units. This may include using coding units (CU) or large coding units (LCU). For this standard, a current frame may be partitioned for compression by a coding 20 partitioner by division into one or more slices of coding tree blocks (e.g., 64×64 luma samples with corresponding chroma samples). Each coding tree block may also be divided into coding units (CU) in quad-tree split scheme. Further, each leaf CU on the quad-tree may either be split again to 4 CU or divided into partition units (PU) for motion-compensated prediction. In various implementations in accordance with the present disclosure, CUs may have various sizes 25 including, but not limited to 64×64, 32×32, 16×16, and 8×8, while for a 2N×2N CU, the corresponding PUs may also have various sizes including, but not limited to, 2N×2N, 2N×N, N×2N, N×N, 2×0.5N, 2N×1.5N, 0.5N×2N, and 1.5N×2N. It should be noted, however, that the foregoing are only example CU partition and PU partition shapes and sizes, the present disclosure not being limited to any particular CU partition and PU partition shapes and/or sizes.

As used herein, the term “block” may refer to a CU, or to a PU of video data for HEVC and the like, or otherwise a 4×4 or 8×8 or other not necessary rectangular shaped block. By some alternatives, this may include considering the block as a division of a macroblock of video or pixel data for H.264/AVC and the like, unless defined otherwise.

Also in video coding system 100, the current video frame divided into LCU, CU, and/or PU units may be provided to the motion estimation unit or estimator 132. System 100 may 5 process the current frame in the designated units of an image in raster or different scan order. When video coding system 100 is operated in inter-prediction mode, motion estimation unit 132 may generate a motion vector in response to the current video frame and a reference video frame. A block-based search method described herein may be used to match a block of a current frame with candidate blocks on reference frame, and thereby determine a motion vector to be encoded 10 for a prediction block. The motion compensation module 134 may then use the reference video frame and the motion vector provided by motion estimation module 132 to generate the predicted frame.

The predicted block may then be subtracted at subtractor 106 from the current block, and the resulting residual is provided to the residual coding partitioner 108. Coding partitioner 108 15 may partition the residual into one or more blocks, and by one form for HEVC, dividing CUs further into transform units (TU) for transform or further compression, and the result may be provided to a transform module 110. The relevant block or unit is transformed into coefficients using variable block size discrete cosine transform (VBS DCT) and/or 4×4 discrete sine transform (DST) to name a few examples. Using the quantization parameter (Qp) set by the 20 controller 116, the quantizer 112 then uses lossy resampling or quantization on the coefficients. The generated set of quantized transform coefficients may be reordered and entropy coded by entropy coding module 114 to generate a portion of a compressed bitstream (for example, a Network Abstraction Layer (NAL) bitstream) provided by video coding system 100. In various implementations, a bitstream provided by video coding system 100 may include entropy-encoded 25 coefficients in addition to side information used to decode each block (e.g., prediction modes, quantization parameters, motion vector information, partition information, in-loop filtering information, and so forth), and may be provided to other systems and/or devices as described herein for transmission or storage.

The output of the quantization module 112 also may be provided to de-quantization unit 30 118 and inverse transform module 120 in a decoding loop. De-quantization unit 118 and inverse transform module 120 may implement the inverse of the operations undertaken by transform unit 110 and quantization module 112. A residual assembler unit 122 may then reconstruct the residual CUs from the TUs. The output of the residual assembler unit 122 then may be combined at adder 124 with the predicted frame to generate a rough reconstructed block. A prediction unit (LCU) assembler 126 then reconstructs the LCUs from the CUs to complete the frame reconstruction.

The quality of the reconstructed frame is then improved by running the frame through the filters 128. The filtered frames are then provided to a decoded picture buffer 130 where the frames may be used as reference frames to construct a corresponding predictions for motion estimation and compensation as explained herein. When video coding system 100 is operated in intra-prediction mode, intra-frame prediction module 136 may use the reconstructed pixels of the 10 current frame to undertake intra-prediction schemes that will not to be described in greater detail herein.

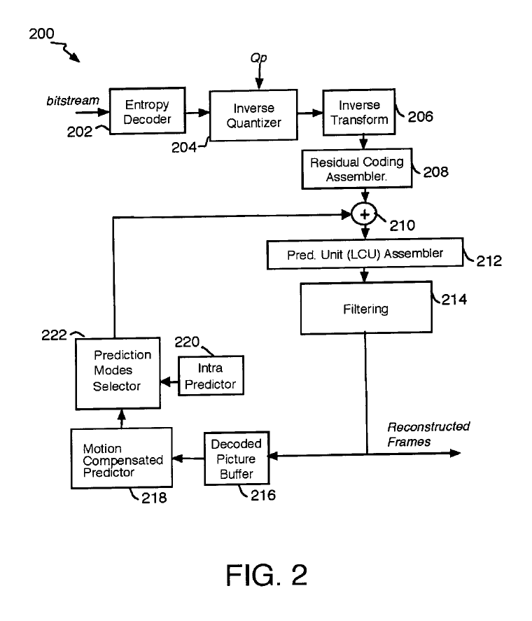

Referring to FIG. 2, a system 200 may have, or may be, a decoder, and may receive coded video data in the form of bitstream 202. The system 200 may process the bitstream with an entropy decoding module 204 to extract quantized residual coefficients as well as the motion 15 vectors, prediction modes, partitions, quantization parameters, filter information, and so forth. The system 200 may then use an inverse quantization module 204 and inverse transform module 206 to reconstruct the residual pixel data. The system 200 may then use a residual coding assembler 208, an adder 210 to add the residual to the predicted block, and a prediction unit (LCU) assembler 212. The system 200 also may decode the resulting data using a decoding loop 20 employing, depending on the coding mode indicated in syntax of bitstream 202 and implemented via prediction mode switch or selector (which also may be referred to as a syntax control module) 222, either a first path including an intra prediction module 220 or a second path inter-prediction decoding path including one or more filters 214. The second path may have a decoded picture buffer 216 to store the reconstructed and filtered frames for use as reference frames as well as to 25 send off the reconstructed frames for display or storage for later viewing or another application or device. A motion compensated predictor 218 utilizes reconstructed frames from the decoded picture buffer 216 as well as motion vectors from the bitstream to reconstruct a predicted block. Thus, the decoder does not need its own motion estimation unit since the motion vectors are already provided, although it still may have one if the decoder actually includes an encoding 30 capability as well. A prediction modes selector 222 sets the correct mode for each block, and a PU assembler (not shown) may be provided at the output of the selector 222 before the blocks are provided to the adder 210. The functionality of modules described herein for systems 100 and 200, except for the motion estimation unit 132 described in detail below, are well recognized in the art and will not be described in any greater detail herein.

For one example implementation, a fast, log motion estimation process using multiple passes and with center shifts is described as follows.

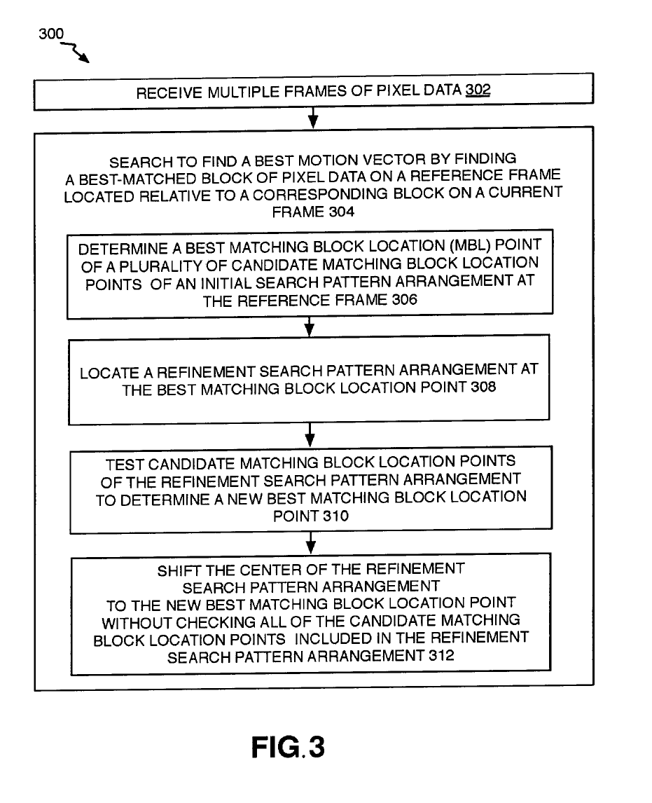

Referring to FIG. 3, a flow chart illustrates an example process 300, arranged in accordance with at least some implementations of the present disclosure. In general, process 300 may provide a computer-implemented method of motion estimation for video coding as mentioned above. In the illustrated implementation, process 300 may include one or more operations, functions or actions as illustrated by one or more of operations 302 to 312 numbered evenly. By 10 way of non-limiting example, process 300 will be described herein with reference to operations discussed with respect to FIGS. 1-2 above and may be discussed with regard to example systems 100, 200 or 1200 discussed below.

The process 300 may comprise “receive multiple frames of pixel data” 302, and particularly at a motion estimation unit within a decoding loop that receives reconstructed and 15 filtered reference frames from buffer 130 as well as data of current frames to be encoded.

The process 300 also may comprise “search to find a best motion vector by finding a best-matching block of pixel data on a reference frame located relative to a corresponding block on a current frame” 304. Once the best match is determined, the process 300 may include using the motion vector of the matching blocks to form a prediction block. To accomplish this, the search 20 operation for motion estimation may include “determine a best matching block location (MBL) point of a plurality of candidate matching block location points of an initial search pattern arrangement at the reference frame” 306. Particularly, an initial search pattern arrangement may be superimposed on a reference frame by using an initial motion vector as discussed below. The initial search pattern arrangement has patterns with a certain shape and certain number of 25 candidate matching block location points (also referred to herein simply as locations) that are checked to find a best matching block location point corresponding to a block on the current frame to be encoded. Thus, each candidate matching block location point represents a block location with coordinates for a motion vector. The point may be the center, upper-left corner, or other part of the block for example. Once the best MBL point is determined on the initial search 30 pattern arrangement, a refinement stage may be initiated.

The process 300 then may comprise “locate a refinement search pattern arrangement at the best matching block location point” 308. For one example, this comprises locating a center of the refinement search pattern arrangement at a best matching block location point. With this pattern arrangement, each pattern that is checked may extend about the center of the refinement search 5 pattern arrangement, and in one example, the shape of the individual patterns may be diamonds, squares, or modifications thereof or other shapes, and where a pattern may be placed at a number of different distances or steps (or scaled to multiple steps) from the center as described below.

The process 300 also may comprise “test candidate matching block location points of the refinement search pattern arrangement to determine a new best matching block location point” 10 310. As explained in detail below, candidate MBL points are tested pattern by pattern until a better MBL point is found on one of the patterns and at one of the steps.

Process 300 then may include “shift the center of the refinement search pattern arrangement to the new best matching block location point without checking all of the candidate matching block location points included in the refinement search pattern arrangement” 312. By 15 one example, this includes shifting the center of the refinement search pattern arrangement to the new best matching block location point without checking all of the candidate matching block location points of patterns at a smaller step included in the refinement search pattern arrangement. Particularly, once the new best MBL point is found on the reference frame, the center of the refinement search pattern arrangement is shifted over the new found MBL point. By 20 one approach, since the process checks the candidate MBL points of the refinement search pattern arrangement pattern by pattern, this center shift may occur whenever the process finds that a pattern has found a new best MBL point. By one approach, the center shift occurs after all candidate MBL points on a pattern at the step with the new best found MBL point are checked. Then, going forward, the refinement search pattern arrangement is shifted so that the patterns 25 extend around the new shifted center.

By one example aspect, the testing of the candidate MBL points on the shifted refinement search arrangement may begin at the pattern with the same step (distance from shifted center) as the step of the pattern at which the better MBL point was found before the most recent center shift. Then, once the testing of a pattern is completed and no new best MBL point is found, the 30 testing continues by reducing the step to a pattern closer to the center of the refinement search pattern arrangement to test the candidate MBL points pattern by pattern. This may be repeated for each of the refinement arrangement patterns. More details are described below.

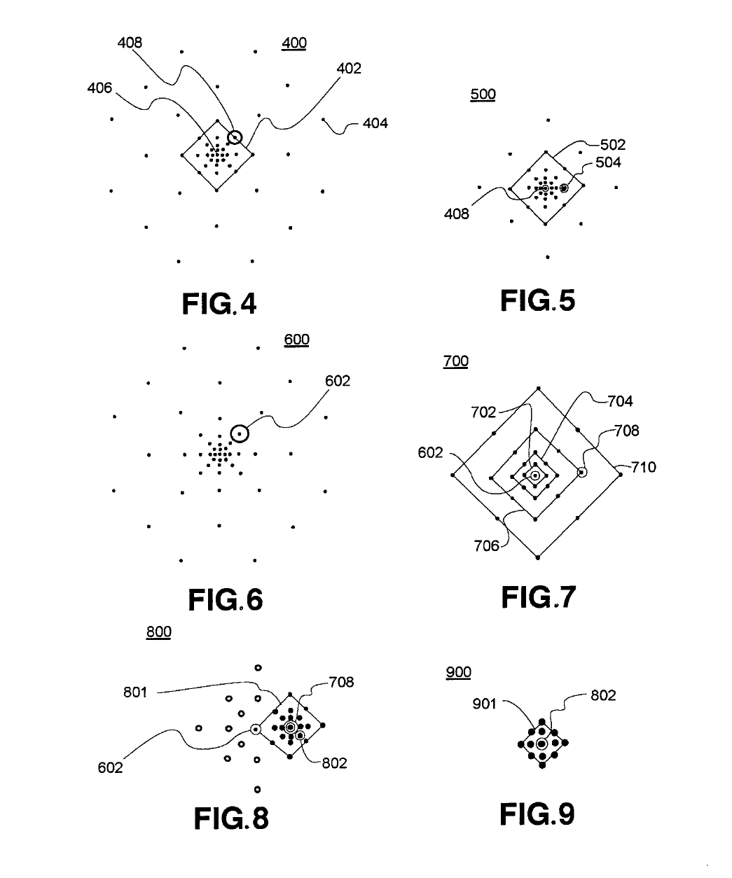

Referring now to FIGS. 4-5, example search pattern arrangements are provided to explain the process. The process here may be a modification of a test zone (TZ) search process in that it has both an initial stage and a refinement stage. The motion estimation search processes may include an initial search pattern arrangement 400 superimposed over a reference frame by using 5 an initial motion vector to locate a center of the initial search pattern arrangement. The initial search pattern arrangement 400 may include a number of patterns 402 where each ring of candidate matching block location (MBL) points 404 extending around a center point 406 forms one of the patterns 402. The individual candidate MBL points are tested or checked by comparing a block (or other defined area) of pixel data at the candidate MBL point with a current 10 block of pixel data on a current frame. The matching is determined by using algorithms such as SAD, MSE, or others as well as determining a total cost in bits of an encoded block as described below.

Once an initial best MBL point 408 is determined, the refinement stage is performed and a center of a refinement search pattern arrangement 500 is located at the location of the best MBL point 408 from the initial stage. The refinement search pattern arrangement may be the same or different than the initial search pattern arrangement. A search is performed of the patterns 502 of the refinement search pattern arrangement until a new best MBL point 504 is found. Each ring (such as a square or diamond shape) around the center 408 may be considered a pattern 502, and a number of possible patterns that could be used for the arrangement are shown. In the conventional motion estimation search process, the search starts with the pattern closest to the center of the refinement search pattern arrangement, or the pattern with the smallest step (step=1). The patterns are searched pattern by pattern by increasing the step, and in one form all of the patterns of the arrangement 500 are checked before determining which candidate MBL point is the new best MBL point. The search then may end here, and a motion vector may be developed based on the coordinates of the new best MBL point 504.

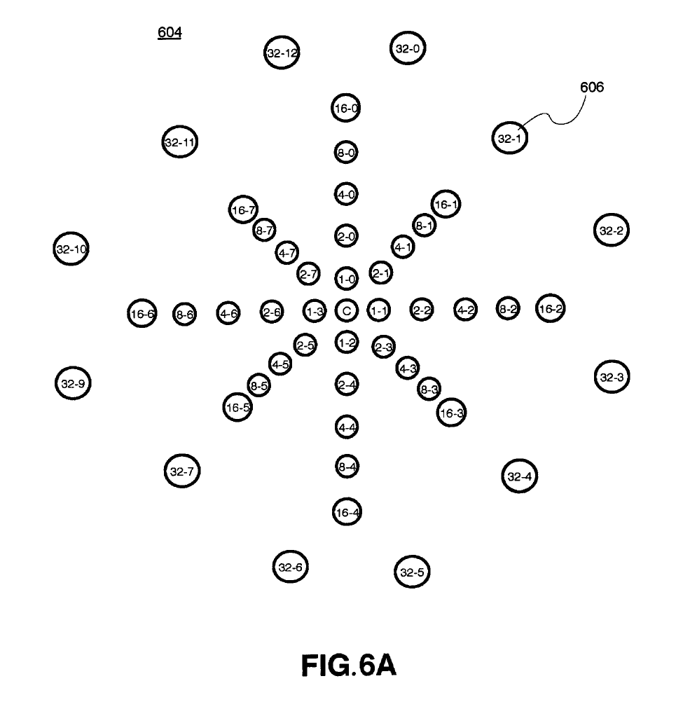

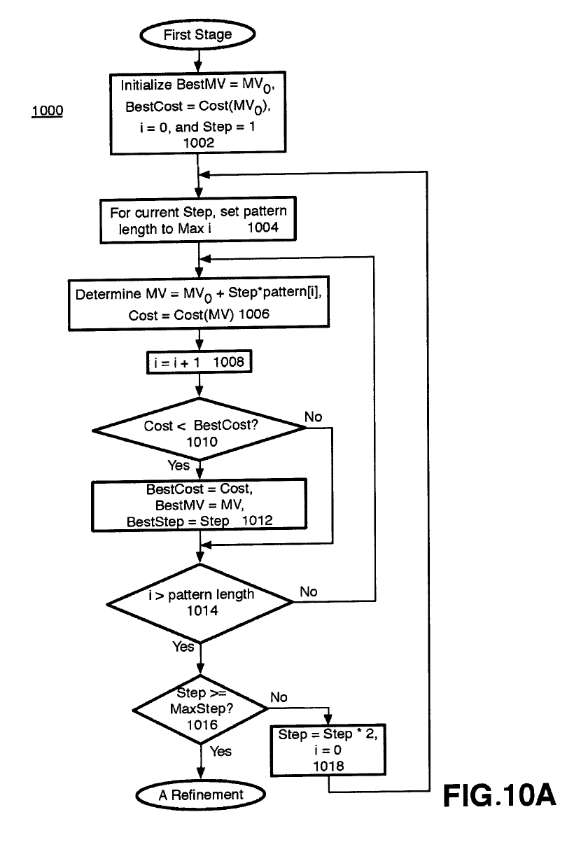

Referring to FIGS. 6-9 and 6A, to describe the additional features provided by the improved center-shifting search process, a search pattern arrangement 600 may be used in an initial search stage and superimposed on a grid of pixel locations of a reference frame where each point shown is at a vertex of such a grid and is located at a pixel location. As with initial search 30 pattern arrangement 400, first stage (or initial) search pattern arrangement 600 is located based on an initial motion vector, a search is performed, which may start with the closest pattern to the center and move outward, with increased step, pattern by pattern to test all of the patterns in the arrangement, during which a best matching block location (MBL) point 602 is determined. One example search pattern arrangement 604 (FIG. 6A) may be used where c is the center point set at a pixel location on the reference frame, and located depending on the initial motion vector. Note that the search pattern arrangement 604 is not drawn to scale and is provided merely to explain 5 the general position of the points and patterns. In the present case, each pattern extends around center point c and has a particular shape. The pattern A (at step 1) is searched first, and in this example, includes candidate MBL points 1-0 to 1-3 in the shape of a small four-point diamond (where 0 may be considered the first point in the pattern). The candidate MBL points may be tested in any order, and it may be the same or different from pattern to pattern. The remaining 10 steps are arranged in logarithmic pattern (geometric progression) and multiplied by two as the pattern is located away from the center c. Steps 2, 4, 8, and 16 all have the same eight-point diamond pattern B and are numbered according to their step. Thus, the pattern of step 2 includes points 2-0 to 2-7, and the pattern of step 16 includes points 16-0 to 16-7. The candidate MBL points at a pattern C of step 32 may be shaped in a diamond shape with cut off corners or 15 additional middle points or an uneven octagonal shape where the diagonal sides are longer than the horizontal and vertical sides. For the step 32, there may be three candidate MBL points on each diagonal side for a total of twelve points (32-0 to 32-11). In pseudo code, the normalized patterns may be expressed as follows:

const int patternA[4][2]={{0,−1}, {1,0}, {0,1}, {31 1,0}}; // small diamond

const float PatternB[8][2]={{−0.5, −0.5}, {0,−1}, {0.5,−0.5}, 55 1,0}, {0.5,0.5}, {0,1}, {−0.5,0.5}, {−1,0}}; // diamond

const float PatternC[12][2]={{−0.75,−0.25}, {31 0.5,−0.5}, {−0.25,−0.75}, {0.25,−0.75}, {0.5,−0.5}, {0.75,−0.25}, {0.75,0.25}, {0.5,0.5}, {0.25,0.75}, {−0.25,0.75}, {−0.5,0.5}, {−0.75,0.25}}; // rounded diamond

where pattern[I][J] refers to the total (I) number of candidate MBL points on the pattern, and total (J) number of coordinates for each point. The geometric distance to the center is not always exactly the same as the step value. Also, as clear from this code then, the coordinates of the candidate MBL points of PatternB are multiplied by the step by one example to obtain the pattern at steps 2, 4, 8, and 16 on FIG. 6A, and similarly the coordinates of PatternC are multiplied by 32 30 for step 32. It will be noted that the pattern arrangement may have many variations and is not always limited to the example pattern arrangement used here. By one form, the same search arrangement pattern is used in both the initial stage and the refinement stage as described below and as shown on FIGS. 7-9 except that the maximum step is the best step of the prior arrangement in the refinement stage, and the minimum step can be greater than 1.

Referring to FIG. 7, a first refinement search pattern arrangement 700 has its center located 5 at the best MBL point 602 from the initial stage. The best step from the initial search arrangement (Step=8) is now set as the maximum step for the refinement search pattern arrangement 700. The search will then proceed by looking for a new best MBL point first at the pattern of step 8 710. If not found, the step is now reduced, here to Step 4 to search the pattern at Step 4 706 where an example new best MBL point 708 is found. If one is found, the refinement 10 search arrangement center is shifted to that new best MBL point, and the search begins again at a different center as shown on the refinement pattern arrangement 800 (FIG. 8). Searching at smaller patterns with steps 2 704 and step 1 702 can be omitted in this example but are still shown on FIG. 8 as possible patterns that could be used for the search pattern arrangement 800.

Other options are contemplated where the present process may or may not remain enabled 15 throughout all of the refinement iterations. One alternative may include finding multiple best locations on a pattern of the first stage pattern arrangement or first refinement stage pattern arrangement for example, such as two or three or other fixed number, and the refinement process may continue separately with each best location and the resulting motion vectors for each location may be compared or combined into a single best motion vector. Many variations are 20 contemplated.

Now, the search then starts again at step 4 relative to the new shifted center point which is the same step value as that where the new best MBL point 708 was found. The search continues step by step by reducing the step value. Thus, step 4 (pattern 801) is checked first, and in this example, if no new best MBL point is found along a pattern in a particular step, then the step is 25 reduced, and here reduced to step 2 which is then checked. The unfilled circles (FIG. 8) are candidate MBL points from the prior pattern arrangement. In this example, a new best MBL point 802 is found. Since a new best MBL point is found, the center is shifted again to the new best MBL point 802 and locates a new refinement arrangement 900 as shown on FIG. 9, and since the new best MBL point 802 was found at step=2 before the most recent center shift, then 30 the new search starts at step=2 (pattern 901) after the center is shifted. As mentioned below, this may continue until step=1, or there may be other limits, such as shifting the center a fixed number of times, and so forth as explained below. In the example on FIG. 9, no better MBL were found. Motion estimation is finished and point 802 is the best prediction location, the output of the process.

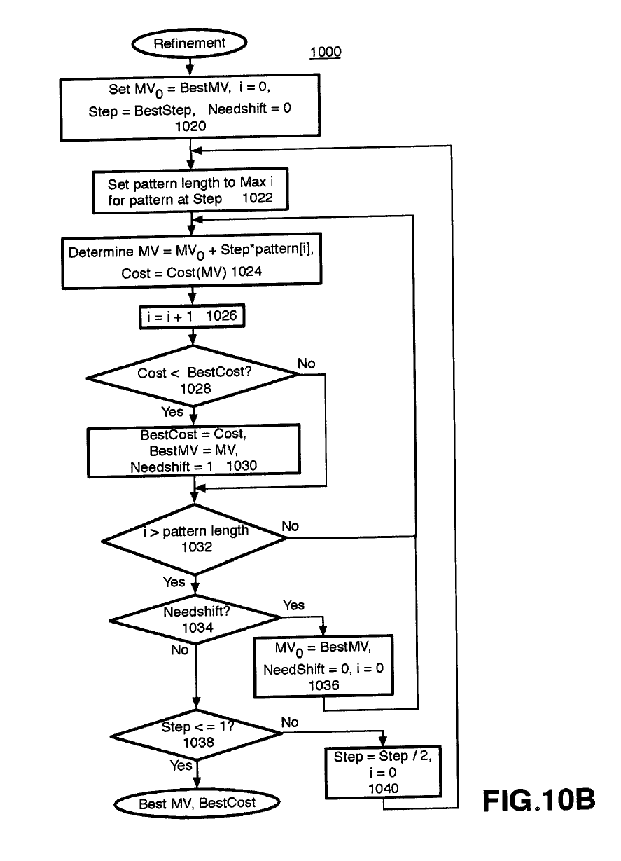

Referring now to FIGS. 10A-10B, a detailed example motion estimation process 1000 is arranged in accordance with at least some implementations of the present disclosure. In general, 5 process 1000 may provide another computer-implemented method of motion estimation for video coding. In the illustrated implementation, process 1000 may include one or more operations, functions or actions as illustrated by one or more of operations 1002 to 1040 numbered evenly. By way of non-limiting example, process 1000 will be described herein with reference to operations discussed with respect to FIGS. 1-9 and 12, and may be discussed with reference to 10 example systems 100 and/or 1200 discussed below.

Process 1000 may start by setting or initializing 1002 some initial variables in an initial or first stage. This may include setting the BestMV to initial motion vector MV₀. Various alternatives for generating the initial motion vector includes using a set of predictors such as neighbor MVs which refers to using a previously determined MV on a block(s) adjacent to the 15 one currently being matched, some combination or median of a number of the neighbor MVs, or an MV from a collocated block in a previous frame. By one approach, more than one of these alternatives are performed, and the best one or combination of the best ones are used as the initial motion vector.

Once it is determined where the initial search pattern arrangement is to be centered, the 20 cost of the block placed at the center is tested, and current BestCost is initialized with this Cost(MV0). Cost in motion estimation usually is calculated as a combination of a measure of the mismatch between the current block on the current frame and the reference block, and the amount of bits used to encode the motion vector.

Also for this operation, step is set to 1, where step is a scale for a search pattern, and for the 25 initial stage which uses a logarithmic scale, the steps will increase by two as described above. A counter i is also set to zero, where the counter is a count of the candidate MBL points on a single pattern.

Process 1000 then may include for the current Step, set 1004 pattern length to Max i, and initially step 1. For step 1 of the example initial search pattern arrangement 604, the pattern A at 30 step 1 has four points (1-0 to 1-3), so pattern length or Max i=4.

The process 1000 then may include determine 1006 a current motion vector MV where:

MV=MVO+Step*pattern[i] (1)

which includes determining a present motion vector or offset from the current block to the block location being matched on the reference frame for current Step and pattern point.

This operation then includes determine the cost of using the block at the candidate MBL point i such that Cost=Cost(MV). As explained above, the cost may include the difference between the matched blocks (the current block on the current frame and the prediction block on the reference frame) as well as the bit cost for encoding current motion vector. i is then incremented (1008).

The process 1000 then may include comparing 1010 the Cost to the BestCost. If the Cost is smaller than the BestCost, then new assignment operations 1012 are performed, such that BestCost, BestMV and BestStep are updated with current values of Cost, motion vector (MV) and Step. If the Cost is greater than the BestCost, then these assignment operations are skipped, and the process continues to match a block at the next candidate MBL point location i on the 15 same pattern on the same Step. This forms a loop that is repeated while i is not greater than the pattern length (1014). In that case, the process loops back to determine the MV and Cost at the new location i on the present pattern at the present step, and the looping continues until i is greater than the pattern length so that the process loops for each candidate MBL point i in the same pattern at the same step.

After the inner pattern loop is finished, the step is checked 1016 to determine whether a MaxStep has been reached. In the present example, the MaxStep is 32, and may be set in many different ways depending on the search pattern arrangement that is desired. If the present Step is less than the MaxStep, then the present Step value is multiplied by 2 (for logarithmic arrangement) and to test the next pattern farther from the center of the search pattern 25 arrangement, and i is reset back to zero to restart the candidate MBL point count (1018). The process then loops back to reset the pattern length to that of the new Step (in the current example, for Step=2, the pattern is pattern B and Max i=8). The process 1000 will then repeat the pattern loop to compare a block at each candidate MBL point at Step*pattern[i] with the current block.

If, on the other hand, the Step being checked is greater than or equal to the present 30 MaxStep, then all of the steps of the initial search pattern arrangement have been checked, the BestCost, BestMV, and BestStep, and in turn the best matching block location point, for the initial search pattern arrangement have been established, and the process moves to the refinement stage.

In the refinement stage, the refinement search pattern arrangement center is set to the best 5 matching block location point of the initial search pattern arrangement. This may mean moving or superimposing, the center point of the refinement search pattern arrangement to the best MBL point from the initial search pattern arrangement. As mentioned above, in the present example, the initial and first refinement search pattern arrangements may be the same except that the maximum step for the refinement search pattern arrangement is the same as the step that the best 10 MBL point was found in the initial search pattern arrangement.

Thus, to set up 1020 the refinement stage, the process 1000 includes setting MV₀ to the resulting BestMV from the initial stage, setting Step at BestStep from the initial stage (and which is now the maximum step for the refinement search pattern arrangement), setting i=0 to restart the count of the of candidate MBL points to be checked, and now setting a needshift to 0 where 0 15 will mean no center-shift, and 1 means center-shift needed.

The process 1000 then may include setting 1022 the pattern length (Max i) for the pattern at Step. By the present example (FIGS. 6-7), for Step=8 (pattern B), then pattern length=8 as well as shown by the coding above. The process then proceeds similarly to the initial stage including determining 1024 MV by equation (1) above and by determining the Cost of using that 20 MV. The process 1000 also includes incrementing i (1026), and comparison 1028 of Cost and BestCost.

If Cost is less than BestCost, new best values are set 1030 as the present values (BestCost=Cost, BestMV=MV). In addition, since a new BestMV is found, and in turn a new best MBL point is found on the present pattern at the present Step, this results in a center shift of the 25 refinement search pattern arrangement to this new point. Thus, needshift is now set to 1.

If no new BestCost is found (Cost is equal to or greater than BestCost), it is determined 1032 whether i is greater than the pattern length at the present Step. If not, then the process loops back up to determine MV for the new value of i. This loop keeps repeating until all of the candidate MBL points i on a pattern at a single step has been tested. Once i is greater than the 30 pattern length, it is determined 1034 whether a center shift is needed (needshift is yes or 1 if a better MBL was found for the current pattern). If a new BestCost (and in turn new best MBL point) was found, and thus, the center of the refinement search pattern arrangement is to be shifted, then MV₀ is set 1036 to BestMV, effectively shifting the center of the refinement search pattern arrangement to the previous best new MBL point, needshift is reset to 0, and i is reset to 5 0. The process then loops back to setting the pattern length and determining the present MV and so forth. This loop occurs to restart the testing of the pattern at the same Step value at new center. Thus, as explained elsewhere, when the previous best MBL point is found at Step 8, then after the center is shifted, the search will also begin at Step 8 as shown in FIGS. 6-7. When the center is shifted, there is no decrease in Step for a first pattern loop.

If no center shift is needed, or in other words if no new best MBL point was found on the pattern at the current step, then the step is reduced to test closer locations using the next pattern with a smaller step. Thus, the process 1000 may include determining 1038 whether Step is greater than 1. If so, Step is divided 1040 by two (when a logarithmic arrangement is used) to obtain the new, reduced Step value, i is reset to zero to restart the count of candidate MBL points 15 for the pattern of the new step, and the process loops back to set a pattern length for the new reduced step about to be tested. The loop for checking all of the candidate MBL points at the new step is then performed.

By one approach, the refinement process repeats while the Step is greater than one (1038). Once the Step=1, then the final BestMV and BestCost are determined, and the BestMV is the 20 final motion vector found by this search process.

Various restrictions may be applied to limit the number of times a center can be shifted to limit the duration of motion estimation, or to limit the motion vector length for example. Thus, the number of center shifts may be a fixed number, an association with a permissible range or value of motion vector length, and/or duration to check a refinement search pattern arrangement.

Setting of the maximum step at the BestStep and then reducing the Step as testing of patterns proceeds is found to be very efficient. If the process begins the refinement stage at step 1, a local minimum (BestCost) may be found quickly, but when the best MBL point is at a larger Step, further refinement will be needed, i.e., to check from the closest to more distant locations using a minimal step. Thus, the present process is more likely to be a one-pass refinement in 30 comparison.

The present process increases the chances of finding the ideal (or better than a traditional method) final best MBL point. If the final best point is located in the center or close to it (step 1 or 2) as obtained from the first stage, there may be no difference in the traditional and proposed approaches. However, if the final point is farther from the center (at a larger step), then the 5 center-shifting process disclosed herein has a much greater chance to reach the ideal best MBL point because it tests more locations around a current best point found at the larger step. Also, the algorithm moves the search to far locations with large steps, thus making such ME performance effective.

```
  The pseudo code used for shifting the center may be as follows:
  10 // first pass is not changed
  for (step = 1; step <= maxstep; step *= 2) { // pattern arrangement
  loop
  cost = CheckDiamond(step, centerPoint, &bestDiamondPoint); //
  pattern loop
  if (cost < bestCost) {
  bestCost = cost;
  bestStep = step;
  bestPoint = bestDiamondPoint;
  }
  }
  // second pass
  centerPoint = bestPoint;
  for (step = bestStep / 2; step >= 1; step /= 2) { // pattern
  arrangement loop
cost = CheckDiamond(step, centerPoint, &bestDiamondPoint); //
```

pattern loop

if (cost < bestCost) {
bestCost = cost;
bestPoint = bestDiamondPoint;
// Improving code:
centerPoint = bestPoint; // shift the center
step *= 2; // to repeat with the same step
// End of improving code.
}
}

By yet other alternatives, while the present process uses full-pel search, fractional-pel search may be used in a very limited range somewhere between neighboring full pixels. In this case, a raster-based search may be used. While a TZ search can be changed to a raster search if a best MV found in a first stage is long, i.e. the BestStep is large, it decreases performance in order 5 to find a better MV. The proposed approach provides better results, and allows finding of a good MV about the same quality as a full search but much faster.

In yet another alternative, instead of basing the search on a Step before shifting the center, the process may be based on another section of the search pattern arrangement that is tested before shifting the center. This might be geometrical such as a quadrant or certain continuous 10 area or portion of the search pattern arrangement, or the candidate MBL points may be checked radially or linearly instead of step by step, and so forth. After each defined area or section is checked, then the center may be shifted. In this way, a pattern at a step may be considered merely one possible type of section of a search pattern arrangement that is checked before shifting the center of the arrangement. By yet another alternative, the center may be shifted after finding a 15 new best MBL point, but before testing another candidate MBL point, or at least before testing all of the points on the pattern, rather than waiting to test an entire section or pattern at a step.

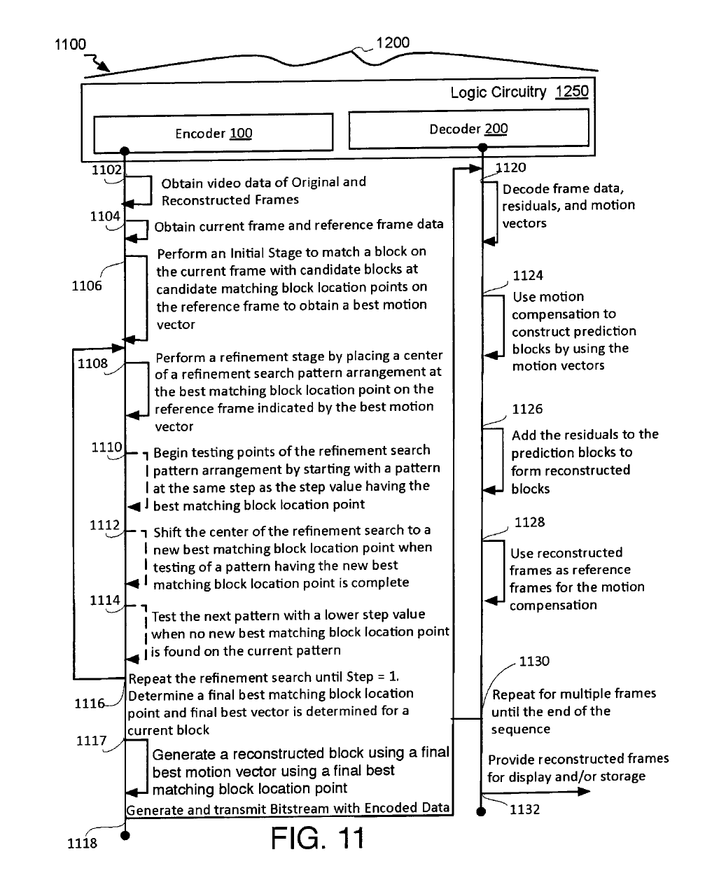

Referring now to FIG. 11, system 1100 may be used for an example center-shifting block search motion estimation process 1100 shown in operation, and arranged in accordance with at least some implementations of the present disclosure. In the illustrated implementation, process 20 1100 may include one or more operations, functions, or actions as illustrated by one or more of actions 1102 to 1132 numbered evenly, and used alternatively or in any combination. By way of non-limiting example, process 1100 will be described herein with reference to operations discussed with respect to any of the implementations described herein.

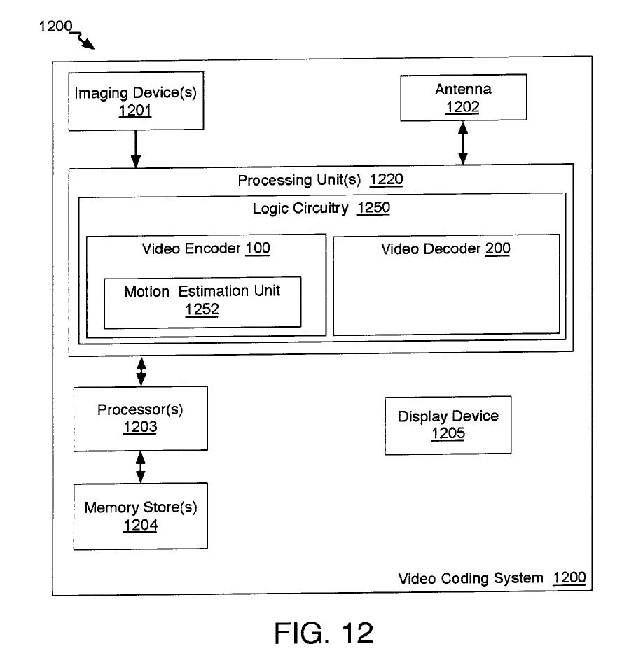

In the illustrated implementation, system 1200 may include a processing unit 1120 with 25 logic units or logic circuitry or modules 1250, the like, and/or combinations thereof. For one example, logic circuitry or modules 1250 may include the video encoder 100 with a motion estimation unit 1252 and optionally the video decoder 200. Although system 1200, s shown in FIG. 12, may include one particular set of operations or actions associated with particular modules, these operations or actions may be associated with different modules than the particular 30 module illustrated here.

Process 1100 may include “obtain video data of original and reconstructed frames” 1102, where the system, or specifically a motion estimation unit at the encoder, may obtain access to pixel data of reconstructed frames. The data may be obtained or read from RAM or ROM, or from another permanent or temporary memory, memory drive, or library as described on systems 5 1200 or 1300, or otherwise from an image capture device. The access may be continuous access for analysis of an ongoing video stream for example. Process 1100 then may include “obtain current frame and reference frame data” 1104 of a reconstructed frame so that blocks to be encoded can be matched to reference blocks during the motion estimation search.

The process 1100 may include “perform an initial stage to match a block on the current 10 frame with candidate blocks at candidate matching block location points on the reference frame to obtain a best motion vector” 1106, and particularly to form an initial best motion vector. This may include using an initial search pattern arrangement with multiple patterns extending around a center point of the arrangement. The search proceeds by testing candidate matching block locations pattern by pattern, and by one form, starting at the closest pattern to the center (step 1) 15 and increasing the pattern (or step) outward until the outer-most pattern (or pattern at largest step or scale) is reached. By the example herein, largest step=32 (FIG. 6A).

Process 1100 may include “perform a refinement stage by placing a center of a refinement search pattern arrangement at the best matching block location point on the reference frame indicated by the best motion vector” 1108. As explained herein, the center point of the 20 refinement search pattern is placed at the pixel location of the best MBL point from the previous search and on the reference frame. Thus, the current or new refinement search pattern is superimposed over the reference frame about that new center point.

Process 1100 may include “begin testing points of the refinement search pattern arrangement by starting with a pattern at the same step as the step value having the best matching 25 block location point” 1110. As explained above for example, if the step with the best MBL point is step=8, whether or not it that point is found during the initial stage or a previous refinement search, the testing of the candidate MBL points at the new refinement search pattern arrangement now starts at step=8 as well.

Process 1100 then may include “shift the center of the refinement search to a new best 30 matching block location point when testing of a pattern having the new best matching block location point is complete” 1112. Thus, the testing proceeds through the pattern, and the testing of the entire pattern is completed (all of the candidate MBL points on the pattern are tested) before shifting the refinement search pattern arrangement to a new center at a new pixel location. Other options include shifting the refinement search pattern arrangement as soon as a new best found MBL point is found but otherwise without completing the testing of all points on the 5 pattern. In some cases, there may need to be a minimum number of points tested that is less than all of the points, by other options the center is shifted as soon as a new best point is found. Many variations are contemplated.

Process 1100 may continue with “test the next pattern with a lower step value when no new best matching block location point is found on the current pattern” 1114. Since the step will 10 reduce on the refinement search pattern arrangements and will not be increased, setting the same step as the previous step for the pattern to search first can be considered to be setting the maximum step size for that new or shifted refinement search pattern arrangement. As shown in process 1000, this may be performed in coding by dividing the step value by the same multiplier used to increase the step value in the initial stage and when a logarithmic pattern arrangement is 15 used, for example.

Process 1100 also may then loop to “repeat the refinement search until step equals 1. Determine a final best matching block location point and final best vector for a current block” 1116. Thus, the process actually loops for each pattern to test all of the candidate MBL points in that pattern, and then loops to test pattern with a smaller step than the current pattern in an 20 arrangement until a new best MBL point is found, and the arrangement is shifted. In the refinement stage when the steps are reduced as explained above, the search may be completed once step=1 if there are no other limits on the number of permissible center shifts as explained herein.

Process 1100 then may include “generate a reconstructed block using a final best motion 25 vector generated by using a final best matching block location point” 1117.

Process 1100 then may include “generate and transmit a bitstream with encoded data” 1118, including transmission of frame data, residual data, and motion vector data. The decoder 200 then may be provided to “decode frame data, residuals, and motion vectors” 1120, “use motion compensation to construct prediction blocks by using the motion vectors” 1124, and “add the 30 residuals to the prediction blocks to form reconstructed blocks” 1126. Process 1100 then may continue with “use reconstructed frames as reference frames for the motion compensation” 1128, and “repeat for multiple frames until the end of the sequence” 1130. The reconstructed frames also may be provided for display and/or storage 1132.

It will be appreciated in one efficient form, the process 1100 includes all three of (1) begin testing of points on a refinement search pattern arrangement at the same step as the step where a 5 best matching block location point is found on the previous pattern arrangement (or position thereof), (2) shifting the center of the search pattern arrangement when a new best matching block location is found on a pattern, and by one approach, once the testing of the pattern is complete, and (3) reducing the step to test the next pattern closer to the center when no new best matching block location point is found. By other alternatives, however, a block-based motion 10 estimation search process may only have (2) alone, or any combination of these that include (2).

In general, process 1100 may be repeated any number of times either in serial or in parallel, as needed. Furthermore, in general, logic units or logic modules, such as that used by encoder 100 and decoder 200 may be implemented, at least in part, by hardware, software, firmware, or any combination thereof. As shown, in some implementations, encoder and decoder 100/200 may 15 be implemented via processor(s) 1203. In other implementations, the coders 100/200 may be implemented via hardware or software implemented via one or more other central processing unit(s). In general, coders 100/200 and/or the operations discussed herein may be enabled at a system level. Some parts, however, for enabling the center-shifting motion estimation search in an encoding loop, and/or otherwise controlling the type of compression scheme or compression 20 ratio used, may be provided or adjusted at a user level, for example.

It will be appreciated that this center-shifting block search fast motion estimation process disclosed herein may be provided on a system that uses alternative search strategies where this strategy is only one option used, or where a group of different motion estimation processes are used and the one with the best result is ultimately used for encoding, or where the results from a 25 number of the search processes are combined, such as a mean or median, and then the combination result is used. This may include direct methods such as block-based searches with alternative search pattern arrangements for example, and/or phase correlation, frequency domain, pixel recursive, and/or optical flow-based algorithms, and/or indirect methods such as corner detection, object tracking and other statistical function based algorithms.

30 While implementation of example process 300, 1000, and/or 1100 may include the

undertaking of all operations shown in the order illustrated, the present disclosure is not limited in this regard and, in various examples, implementation of any of the processes herein may include the undertaking of only a subset of the operations shown and/or in a different order than illustrated.

In implementations, features described herein may be undertaken in response to 5 instructions provided by one or more computer program products. Such program products may include signal bearing media providing instructions that, when executed by, for example, a processor, may provide the functionality described herein. The computer program products may be provided in any form of one or more machine-readable media. Thus, for example, a processor including one or more processor core(s) may undertake one or more features described herein in 10 response to program code and/or instructions or instruction sets conveyed to the processor by one or more machine-readable media. In general, a machine-readable medium may convey software in the form of program code and/or instructions or instruction sets that may cause any of the devices and/or systems described herein to implement at least portions of the features described herein. As mentioned previously, in another form, a non-transitory article, such as a non-15 transitory computer readable medium, may be used with any of the examples mentioned above or other examples except that it does not include a transitory signal per se. It does include those elements other than a signal per se that may hold data temporarily in a “transitory” fashion such as RAM and so forth.

As used in any implementation described herein, the term “module” refers to any 20 combination of software logic, firmware logic and/or hardware logic configured to provide the functionality described herein. The software may be embodied as a software package, code and/or instruction set or instructions, and “hardware”, as used in any implementation described herein, may include, for example, singly or in any combination, hardwired circuitry, programmable circuitry, state machine circuitry, and/or firmware that stores instructions executed 25 by programmable circuitry. The modules may, collectively or individually, be embodied as circuitry that forms part of a larger system, for example, an integrated circuit (IC), system on-chip (SoC), and so forth. For example, a module may be embodied in logic circuitry for the implementation via software, firmware, or hardware of the coding systems discussed herein.

As used in any implementation described herein, the term “logic unit” refers to any 30 combination of firmware logic and/or hardware logic configured to provide the functionality described herein. The “hardware”, as used in any implementation described herein, may include, for example, singly or in any combination, hardwired circuitry, programmable circuitry, state machine circuitry, and/or firmware that stores instructions executed by programmable circuitry. The logic units may, collectively or individually, be embodied as circuitry that forms part of a larger system, for example, an integrated circuit (IC), system on-chip (SoC), and so forth. For example, a logic unit may be embodied in logic circuitry for the implementation firmware or 5 hardware of the coding systems discussed herein. One of ordinary skill in the art will appreciate that operations performed by hardware and/or firmware may alternatively be implemented via software, which may be embodied as a software package, code and/or instruction set or instructions, and also appreciate that logic unit may also utilize a portion of software to implement its functionality.

As used in any implementation described herein, the term “component” may refer to a module or to a logic unit, as these terms are described above. Accordingly, the term “component” may refer to any combination of software logic, firmware logic, and/or hardware logic configured to provide the functionality described herein. For example, one of ordinary skill in the art will appreciate that operations performed by hardware and/or firmware may alternatively be 15 implemented via a software module, which may be embodied as a software package, code and/or instruction set, and also appreciate that a logic unit may also utilize a portion of software to implement its functionality.

Referring to FIG. 12, an example video coding system 1200 for providing adaptive quality restoration (AQR) filtering of reconstructed frames of a video sequence may be arranged in 20 accordance with at least some implementations of the present disclosure. In the illustrated implementation, system 1200 may include one or more central processing units or processors 1203, a display device 1205, and one or more memory stores 1204. Central processing units 1203, memory store 1204, and/or display device 1205 may be capable of communication with one another, via, for example, a bus, wires, or other access. In various implementations, display 25 device 1205 may be integrated in system 1200 or implemented separately from system 1200.

As shown in FIG. 12, and discussed above, the processing unit 1220 may have logic circuitry 1250 with an encoder 100 and/or a decoder 200. The encoder 100 may have motion estimation unit 1252 to provide many of the functions described herein and as explained with the processes described herein.

As will be appreciated, the modules illustrated in FIG. 12 may include a variety of software and/or hardware modules and/or modules that may be implemented via software or hardware or combinations thereof. For example, the modules may be implemented as software via processing units 1220 or the modules may be implemented via a dedicated hardware portion. Furthermore, the shown memory stores 1204 may be shared memory for processing units 1220, for example. AQR filter data may be stored on any of the options mentioned above, or may be stored on a 5 combination of these options, or may be stored elsewhere. Also, system 1200 may be implemented in a variety of ways. For example, system 1200 (excluding display device 1205) may be implemented as a single chip or device having a graphics processor, a quad-core central processing unit, and/or a memory controller input/output (I/O) module. In other examples, system 1200 (again excluding display device 1205) may be implemented as a chipset.

Processor(s) 1203 may include any suitable implementation including, for example, microprocessor(s), multicore processors, application specific integrated circuits, chip(s), chipsets, programmable logic devices, graphics cards, integrated graphics, general purpose graphics processing unit(s), or the like. In addition, memory stores 1204 may be any type of memory such as volatile memory (e.g., Static Random Access Memory (SRAM), Dynamic Random Access 15 Memory (DRAM), etc.) or non-volatile memory (e.g., flash memory, etc.), and so forth. In a non-limiting example, memory stores 1204 also may be implemented via cache memory. In various examples, system 1200 may be implemented as a chipset or as a system on a chip.

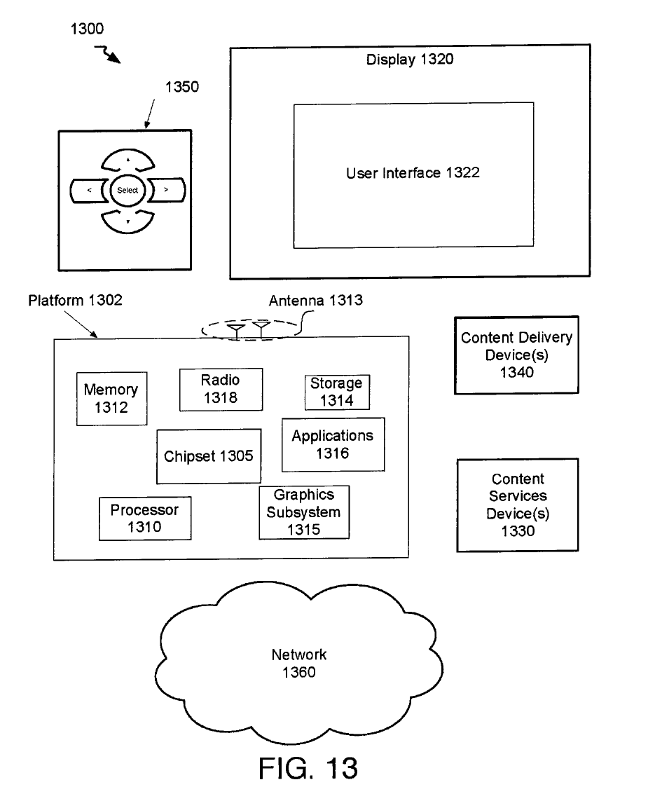

Referring to FIG. 13, an example system 1300 in accordance with the present disclosure and various implementations, may be a media system although system 1300 is not limited to this 20 context. For example, system 1300 may be incorporated into a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or smart television), mobile internet device (MID), messaging device, data communication device, and so forth.

In various implementations, system 1300 includes a platform 1302 communicatively coupled to a display 1320. Platform 1302 may receive content from a content device such as content services device(s) 1330 or content delivery device(s) 1340 or other similar content sources. A navigation controller 1350 including one or more navigation features may be used to interact with, for example, platform 1302 and/or display 1320. Each of these components is 30 described in greater detail below.

In various implementations, platform 1302 may include any combination of a chipset 1305, processor 1310, memory 1312, storage 1314, graphics subsystem 1315, applications 1316 and/or radio 1318 as well as antenna(s) 1313. Chipset 1305 may provide intercommunication among processor 1310, memory 1312, storage 1314, graphics subsystem 1315, applications 1316 and/or 5 radio 1318. For example, chipset 1305 may include a storage adapter (not depicted) capable of providing intercommunication with storage 1314.

Processor 1310 may be implemented as a Complex Instruction Set Computer (CISC) or Reduced Instruction Set Computer (RISC) processors; x86 instruction set compatible processors, multi-core, or any other microprocessor or central processing unit (CPU). In various 10 implementations, processor 1310 may be dual-core processor(s), dual-core mobile processor(s), and so forth.

Memory 1312 may be implemented as a volatile memory device such as, but not limited to, a Random Access Memory (RAM), Dynamic Random Access Memory (DRAM), or Static RAM (SRAM).

Storage 1314 may be implemented as a non-volatile storage device such as, but not limited to, a magnetic disk drive, optical disk drive, tape drive, an internal storage device, an attached storage device, flash memory, battery backed-up SDRAM (synchronous DRAM), and/or a network accessible storage device. In various implementations, storage 1314 may include technology to increase the storage performance enhanced protection for valuable digital media 20 when multiple hard drives are included, for example.

Graphics subsystem 1315 may perform processing of images such as still or video for display. Graphics subsystem 1315 may be a graphics processing unit (GPU) or a visual processing unit (VPU), for example. An analog or digital interface may be used to communicatively couple graphics subsystem 1315 and display 1320. For example, the interface 25 may be any of a High-Definition Multimedia Interface, Display Port, wireless HDMI, and/or wireless HD compliant techniques. Graphics subsystem 1315 may be integrated into processor 1310 or chipset 1305. In some implementations, graphics subsystem 1315 may be a stand-alone card communicatively coupled to chipset 1305.

The graphics and/or video processing techniques described herein may be implemented in 30 various hardware architectures. For example, graphics and/or video functionality may be integrated within a chipset. Alternatively, a discrete graphics and/or video processor may be used. As still another implementation, the graphics and/or video functions may be provided by a general purpose processor, including a multi-core processor. In other implementations, the functions may be implemented in a consumer electronics device.

Radio 1318 may include one or more radios capable of transmitting and receiving signals using various suitable wireless communications techniques. Such techniques may involve communications across one or more wireless networks. Example wireless networks include (but are not limited to) wireless local area networks (WLANs), wireless personal area networks (WPANs), wireless metropolitan area network (WMANs), cellular networks, and satellite 10 networks. In communicating across such networks, radio 1318 may operate in accordance with one or more applicable standards in any version.

In various implementations, display 1320 may include any television type monitor or display. Display 1320 may include, for example, a computer display screen, touch screen display, video monitor, television-like device, and/or a television. Display 1320 may be digital and/or 15 analog. In various implementations, display 1320 may be a holographic display. Also, display 1320 may be a transparent surface that may receive a visual projection. Such projections may convey various forms of information, images, and/or objects. For example, such projections may be a visual overlay for a mobile augmented reality (MAR) application. Under the control of one or more software applications 1316, platform 1302 may display user interface 1322 on display 20 1320.

In various implementations, content services device(s) 1330 may be hosted by any national, international and/or independent service and thus accessible to platform 1302 via the Internet, for example. Content services device(s) 1330 may be coupled to platform 1302 and/or to display 1320. Platform 1302 and/or content services device(s) 1330 may be coupled to a network 1360 to 25 communicate (e.g., send and/or receive) media information to and from network 1360. Content delivery device(s) 1340 also may be coupled to platform 1302 and/or to display 1320.

In various implementations, content services device(s) 1330 may include a cable television box, personal computer, network, telephone, Internet enabled devices or appliance capable of delivering digital information and/or content, and any other similar device capable of 30 unidirectionally or bidirectionally communicating content between content providers and platform 1302 and/display 1320, via network 1360 or directly. It will be appreciated that the content may be communicated unidirectionally and/or bidirectionally to and from any one of the components in system 1300 and a content provider via network 1360. Examples of content may include any media information including, for example, video, music, medical and gaming information, and so forth.

Content services device(s) 1330 may receive content such as cable television programming including media information, digital information, and/or other content. Examples of content providers may include any cable or satellite television or radio or Internet content providers. The provided examples are not meant to limit implementations in accordance with the present disclosure in any way.

In various implementations, platform 1302 may receive control signals from navigation controller 1350 having one or more navigation features. The navigation features of controller 1350 may be used to interact with user interface 1322, for example. In implementations, navigation controller 1350 may be a pointing device that may be a computer hardware component (specifically, a human interface device) that allows a user to input spatial (e.g., 15 continuous and multi-dimensional) data into a computer. Many systems such as graphical user interfaces (GUI), and televisions and monitors allow the user to control and provide data to the computer or television using physical gestures.

Movements of the navigation features of controller 1350 may be replicated on a display (e.g., display 1320) by movements of a pointer, cursor, focus ring, or other visual indicators 20 displayed on the display. For example, under the control of software applications 1316, the navigation features located on navigation controller 1350 may be mapped to virtual navigation features displayed on user interface 1322, for example. In implementations, controller 1350 may not be a separate component but may be integrated into platform 1302 and/or display 1320. The present disclosure, however, is not limited to the elements or in the context shown or described 25 herein.

In various implementations, drivers (not shown) may include technology to enable users to instantly turn on and off platform 1302 like a television with the touch of a button after initial boot-up, when enabled, for example. Program logic may allow platform 1302 to stream content to media adaptors or other content services device(s) 1330 or content delivery device(s) 1340 30 even when the platform is turned “off.” In addition, chipset 1305 may include hardware and/or software support for 7.1 surround sound audio and/or high definition (7.1) surround sound audio, for example. Drivers may include a graphics driver for integrated graphics platforms. In implementations, the graphics driver may comprise a peripheral component interconnect (PCI) Express graphics card.

In various implementations, any one or more of the components shown in system 1300 may 5 be integrated. For example, platform 1302 and content services device(s) 1330 may be integrated, or platform 1302 and content delivery device(s) 1340 may be integrated, or platform 1302, content services device(s) 1330, and content delivery device(s) 1340 may be integrated, for example. In various implementations, platform 1302 and display 1320 may be an integrated unit. Display 1320 and content service device(s) 1330 may be integrated, or display 1320 and content 10 delivery device(s) 1340 may be integrated, for example. These examples are not meant to limit the present disclosure.

In various implementations, system 1300 may be implemented as a wireless system, a wired system, or a combination of both. When implemented as a wireless system, system 1300 may include components and interfaces suitable for communicating over a wireless shared 15 media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 1300 may include components and interfaces suitable for communicating over wired communications media, such as input/output (I/O) adapters, physical connectors to connect the 20 I/O adapter with a corresponding wired communications medium, a network interface card (NIC), disc controller, video controller, audio controller, and the like. Examples of wired communications media may include a wire, cable, metal leads, printed circuit board (PCB), backplane, switch fabric, semiconductor material, twisted-pair wire, co-axial cable, fiber optics, and so forth.

Platform 1302 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, 30 video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The implementations, however, are not limited to the elements or in the context shown or described in FIG. 13.

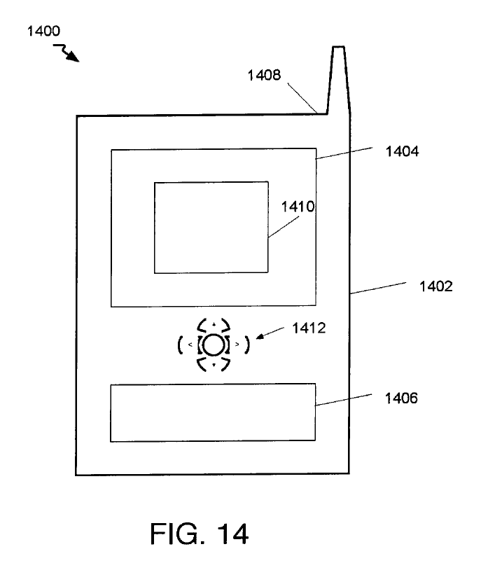

As described above, system 1200 or 1300 may be implemented in varying physical styles or form factors. FIG. 14 illustrates implementations of a small form factor device 1400 in which system 1200 or 1300 may be implemented. In implementations, for example, device 1400 may be implemented as a mobile computing device having wireless capabilities. A mobile computing device may refer to any device having a processing system and a mobile power source or supply, 10 such as one or more batteries, for example.

As described above, examples of a mobile computing device may include a personal computer (PC), laptop computer, ultra-laptop computer, tablet, touch pad, portable computer, handheld computer, palmtop computer, personal digital assistant (PDA), cellular telephone, combination cellular telephone/PDA, television, smart device (e.g., smart phone, smart tablet or 15 smart television), mobile interne device (MID), messaging device, data communication device, and so forth.

Examples of a mobile computing device also may include computers that are arranged to be worn by a person, such as a wrist computer, finger computer, ring computer, eyeglass computer, belt-clip computer, arm-band computer, shoe computers, clothing computers, and 20 other wearable computers. In various implementations, for example, a mobile computing device may be implemented as a smart phone capable of executing computer applications, as well as voice communications and/or data communications. Although some implementations may be described with a mobile computing device implemented as a smart phone by way of example, it may be appreciated that other implementations may be implemented using other wireless mobile 25 computing devices as well. The implementations are not limited in this context.

As shown in FIG. 14, device 1400 may include a housing 1402, a display 1404, an input/output (I/O) device 1406, and an antenna 1408. Device 1400 also may include navigation features 1412. Display 1404 may include any suitable screen 1410 on a display unit for displaying information appropriate for a mobile computing device. I/O device 1406 may include 30 any suitable I/O device for entering information into a mobile computing device. Examples for I/O device 1406 may include an alphanumeric keyboard, a numeric keypad, a touch pad, input keys, buttons, switches, rocker switches, microphones, speakers, voice recognition device and software, and so forth. Information also may be entered into device 1400 by way of microphone (not shown). Such information may be digitized by a voice recognition device (not shown). The implementations are not limited in this context.

Various implementations may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic 10 gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, 15 computer code, code segments, computer code segments, words, values, symbols, or any combination thereof. Determining whether an implementation is implemented using hardware elements and/or software elements may vary in accordance with any number of factors, such as desired computational rate, power levels, heat tolerances, processing cycle budget, input data rates, output data rates, memory resources, data bus speeds and other design or performance 20 constraints.

One or more aspects described above may be implemented by representative instructions stored on a machine-readable medium which represents various logic within the processor, which when read by a machine causes the machine to fabricate logic to perform the techniques described herein. Such representations, known as “IP cores” may be stored on a tangible, 25 machine readable medium and supplied to various customers or manufacturing facilities to load into the fabrication machines that actually make the logic or processor.

While certain features set forth herein have been described with reference to various implementations, this description is not intended to be construed in a limiting sense. Hence, various modifications of the implementations described herein, as well as other implementations, 30 which are apparent to persons skilled in the art to which the present disclosure pertains are deemed to lie within the spirit and scope of the present disclosure.

The following examples pertain to additional implementations.

A computer-implemented method of adaptive quality restoration filtering comprises receiving multiple frames of pixel data; and searching to find a best motion vector by finding a best-matching block of pixel data on a reference frame located relative to a corresponding block 5 on a current frame. The searching comprises determining a best matching block location (MBL) point of a plurality of candidate matching block location points of an initial search pattern arrangement at the reference frame; locating a refinement search pattern arrangement at the best matching block location point; testing candidate matching block location points of the refinement search pattern arrangement to determine a new best matching block location point; and shifting 10 the center of the refinement search pattern arrangement to the new best matching block location point without checking all of the candidate matching block location points included in the refinement search pattern arrangement.

The method also may comprise operations such as forming the refinement search pattern arrangement of a plurality of predefined sections; and shifting the center of the refinement search 15 pattern arrangement after all of the matching block location points in a section have been tested; where each section is a pattern, and the refinement search arrangement is formed of: a plurality of patterns, the same pattern scaled to a plurality of different steps from the center wherein a step is a distance unit extending along a line from the center to a matching block location point in the pattern, or both. A pattern comprises a defined number of candidate matching block location 20 points in a defined shape, and a pattern extends in a ring around the center, where the center is shifted when the new best matching block location point is found after checking one of: at least one of the multiple candidate matching block location points on a pattern at a single step, and after checking all of the multiple candidate matching block location points on a pattern at a single step.

The method also comprises reducing the step size to check candidate matching block location points on patterns increasingly closer to the center of the refinement search pattern arrangement, decreasing the step of the pattern to be checked while checking a first refinement search pattern arrangement directly after the checking of the initial search pattern arrangement, where the step is reduced to check a pattern closer to the center of the refinement search pattern 30 arrangement when a new best matching block location point is not found on a current pattern; setting the maximum step of a pattern of the refinement search pattern arrangement extending about the shifted center to determine a refined best matching block location point, and to be the same step of the pattern having a best matching block location point of a directly previous search pattern arrangement before shifting the center, where the center is shifted multiple times; and limiting the number of times the center may be shifted by at least one of: a fixed number, association with a permissible range or value of motion vector length, and duration to check a 5 refinement search pattern arrangement.

For the method, the initial or refinement search pattern arrangement or both may be a log arrangement with a maximum full arrangement comprising a diamond pattern at a step 1 with four candidate matching block location points, diamond patterns at steps 2, 4, 8, and 16 each with eight candidate matching block location points, and a diamond pattern forming sides of the 10 diamond without corners at a step 32 and having 12 candidate matching block location points with three candidate matching block location points each on a diagonal side of the diamond shape, where the step is a unit distance from the center of the search pattern arrangement.

A system comprises a display, a memory, at least one processor communicatively coupled to the memory and display, and a motion estimation unit operated by the at least one processor 15 and being arranged to: receive multiple frames of pixel data; search to find a best motion vector by finding a best-matching block of pixel data on a reference frame located relative to a corresponding block on a current frame. The searching comprises determining a best matching block location (MBL) point of a plurality of candidate matching block location points of an initial search pattern arrangement at the reference frame; locating a refinement search pattern 20 arrangement at the best matching block location point; testing candidate matching block location points of the refinement search pattern arrangement to determine a new best matching block location point, and shifting the center of the refinement search pattern arrangement to the new best matching block location point without checking all of the candidate matching block location points included in the refinement search pattern arrangement.

The system's motion estimation unit also may be arranged to: form the refinement search pattern arrangement of a plurality of predefined sections; and shift the center of the refinement search pattern arrangement after all of the matching block location points in a section have been tested, where each section is a pattern, and the refinement search arrangement is formed of: a plurality of patterns, the same pattern scaled to a plurality of different steps from the center 30 wherein a step is a distance unit extending along a line from the center to a matching block location point in the pattern, or both, where a pattern comprises a defined number of candidate matching block location points in a defined shape; where a pattern extends in a ring around the center; where the center is shifted when the new best matching block location point is found after checking one of: at least one of the multiple candidate matching block location points on a pattern at a single step, and after checking all of the multiple candidate matching block location points on a pattern at a single step.

The motion estimation unit also may be arranged to: reduce the step size to check candidate matching block location points on patterns increasingly closer to the center of the refinement search pattern arrangement; decrease the step of the pattern to be checked while checking a first refinement search pattern arrangement directly after the checking of the initial search pattern arrangement, wherein the step is reduced to check a pattern closer to the center of the refinement 10 search pattern arrangement when a new best matching block location point is not found on a current pattern; set the maximum step of a pattern of the refinement search pattern arrangement extending about the shifted center to determine a refined best matching block location point, and to be the same step of the pattern having a best matching block location point of a directly previous search pattern arrangement before shifting the center, wherein the center is shifted 15 multiple times; and limit the number of times the center may be shifted by at least one of: a fixed number, association with a permissible range or value of motion vector length, and duration to check a refinement search pattern arrangement.

For the system, the initial or refinement search pattern arrangement or both may be a log arrangement with a maximum full arrangement comprising a diamond pattern at a step 1 with 20 four candidate matching block location points, diamond patterns at steps 2, 4, 8, and 16 each with eight candidate matching block location points, and a diamond pattern forming sides of the diamond without corners at a step 32 and having 12 candidate matching block location points with three candidate matching block location points each on a diagonal side of the diamond shape, where the step is a unit distance from the center of the search pattern arrangement.

A computer readable memory comprising instructions, that when executed by a computing device, cause the computing device to A computer-readable medium having stored thereon instructions that when executed cause a computing device to: receive multiple frames of pixel data; search to find a best motion vector by finding a best-matching block of pixel data on a reference frame located relative to a corresponding block on a current frame. The searching 30 comprises determine a best matching block location point of a plurality of candidate matching block location points of an initial search pattern arrangement at the reference frame; locate a refinement search pattern arrangement at the best matching block location point; test candidate matching block location points of the refinement search pattern arrangement to determine a new best matching block location point, and shift the center of the refinement search pattern arrangement to the new best matching block location point without checking all of the candidate matching block location points included in the refinement search pattern arrangement.

The instructions also may cause the computing device to: form the refinement search pattern arrangement of a plurality of predefined sections; and shift the center of the refinement search pattern arrangement after all of the matching block location points in a section have been tested, where each section is a pattern, and the refinement search arrangement is formed of: a plurality of patterns, the same pattern scaled to a plurality of different steps from the center 10 wherein a step is a distance unit extending along a line from the center to a matching block location point in the pattern, or both, where a pattern comprises a defined number of candidate matching block location points in a defined shape; where a pattern extends in a ring around the center; where the center is shifted when the new best matching block location point is found after checking one of: at least one of the multiple candidate matching block location points on a 15 pattern at a single step, and after checking all of the multiple candidate matching block location points on a pattern at a single step.

The instructions also may cause the computing device to: reduce the step size to check candidate matching block location points on patterns increasingly closer to the center of the refinement search pattern arrangement; decrease the step of the pattern to be checked while 20 checking a first refinement search pattern arrangement directly after the checking of the initial search pattern arrangement, wherein the step is reduced to check a pattern closer to the center of the refinement search pattern arrangement when a new best matching block location point is not found on a current pattern; set the maximum step of a pattern of the refinement search pattern arrangement extending about the shifted center to determine a refined best matching block 25 location point, and to be the same step of the pattern having a best matching block location point of a directly previous search pattern arrangement before shifting the center, wherein the center is shifted multiple times; and limit the number of times the center may be shifted by at least one of: a fixed number, association with a permissible range or value of motion vector length, and duration to check a refinement search pattern arrangement.

For the instructions, the initial or refinement search pattern arrangement or both may be a log arrangement with a maximum full arrangement comprising a diamond pattern at a step 1 with four candidate matching block location points, diamond patterns at steps 2, 4, 8, and 16 each with eight candidate matching block location points, and a diamond pattern forming sides of the diamond without corners at a step 32 and having 12 candidate matching block location points with three candidate matching block location points each on a diagonal side of the diamond shape, wherein the step is a unit distance from the center of the search pattern arrangement.

In another example, at least one machine readable medium may include a plurality of instructions that in response to being executed on a computing device, cause the computing device to perform the method according to any one of the above examples.

In yet another example, an apparatus may include means for performing the methods according to any one of the above examples.

The above examples may include specific combination of features. However, the above examples are not limited in this regard and, in various implementations, the above examples may include undertaking only a subset of such features, undertaking a different order of such features, undertaking a different combination of such features, and/or undertaking additional features than those features explicitly listed. For example, all features described with respect to the example 15 methods may be implemented with respect to the example apparatus, the example systems, and/or the example articles, and vice versa.

1-25. (canceled)

26. A computer-implemented method of motion estimation for video coding comprising:
receiving multiple frames of pixel data; and
searching to find a best motion vector by finding a best-matching block of pixel data on a reference frame located relative to a corresponding block on a current frame, the searching comprising:
determining a best matching block location (MBL) point of a plurality of candidate matching block location points of an initial search pattern arrangement at the reference frame;
locating a refinement search pattern arrangement at the best matching block location point;
testing candidate matching block location points of the refinement search pattern arrangement to determine a new best matching block location point; and
shifting the center of the refinement search pattern arrangement to the new best matching block location point without checking all of the candidate matching block location points included in the refinement search pattern arrangement.

27. The method of claim 26 comprising:
forming the refinement search pattern arrangement of a plurality of predefined sections; and
shifting the center of the refinement search pattern arrangement after all of the matching block location points in a section have been tested.

28. The method of claim 27 wherein each section is a pattern, and the refinement search arrangement is formed of:
a plurality of patterns,
the same pattern scaled to a plurality of different steps from the center wherein a step is a distance unit extending along a line from the center to a matching block location point in the pattern, or both,
wherein a pattern comprises a defined number of candidate matching block location points in a defined shape.

29. The method of claim 28 wherein a pattern extends in a ring around the center.

30. The method of claim 28 wherein the center is shifted when the new best matching block location point is found after checking at least one of the multiple candidate matching block location points on a pattern at a single step.

31. The method of claim 30 wherein the center is shifted after checking all of the multiple candidate matching block location points on a pattern at a single step.

32. The method of claim 28 comprising reducing the step size to check candidate matching block location points on patterns increasingly closer to the center of the refinement search pattern arrangement.

33. The method of claim 32 comprising decreasing the step of the pattern to be checked while checking a first refinement search pattern arrangement directly after the checking of the initial search pattern arrangement.

34. The method of claim 32 wherein the step is reduced to check a pattern closer to the center of the refinement search pattern arrangement when a new best matching block location point is not found on a current pattern.

35. The method of claim 28 comprising setting the maximum step of a pattern of the refinement search pattern arrangement extending about the shifted center to determine a refined best matching block location point, and to be the same step of the pattern having a best matching block location point of a directly previous search pattern arrangement before shifting the center.

36. The method of claim 26 wherein the center is shifted multiple times.

37. The method of claim 26 comprising limiting the number of times the center may be shifted by at least one of:
a fixed number,
association with a permissible range or value of motion vector length, and
duration to check a refinement search pattern arrangement.

38. The method of claim 28 wherein the initial or refinement search pattern arrangement or both is a log arrangement with a maximum full arrangement comprising a diamond pattern at a step 1 with four candidate matching block location points, diamond patterns at steps 2, 4, 8, and 16 each with eight candidate matching block location points, and a diamond pattern forming sides of the diamond without corners at a step 32 and having 12 candidate matching block location points with three candidate matching block location points each on a diagonal side of the diamond shape, wherein the step is a unit distance from the center of the search pattern arrangement.

39. The method of claim 26 comprising:
forming the refinement search pattern arrangement of a plurality of predefined sections; and
shifting the center of the refinement search pattern arrangement after all of the matching block location points in a section have been tested;
wherein each section is a pattern, and the refinement search arrangement is formed of:
a plurality of patterns,
the same pattern scaled to a plurality of different steps from the center wherein a step is a distance unit extending along a line from the center to a matching block location point in the pattern, or both,
wherein a pattern comprises a defined number of candidate matching block location points in a defined shape;
wherein a pattern extends in a ring around the center;
wherein the center is shifted when the new best matching block location point is found after checking one of:
at least one of the multiple candidate matching block location points on a pattern at a single step;
after checking all of the multiple candidate matching block location points on a pattern at a single step;
the method comprising:
reducing the step size to check candidate matching block location points on patterns increasingly closer to the center of the refinement search pattern arrangement;
decreasing the step of the pattern to be checked while checking a first refinement search pattern arrangement directly after the checking of the initial search pattern arrangement, wherein the step is reduced to check a pattern closer to the center of the refinement search pattern arrangement when a new best matching block location point is not found on a current pattern;
setting the maximum step of a pattern of the refinement search pattern arrangement extending about the shifted center to determine a refined best matching block location point, and to be the same step of the pattern having a best matching block location point of a directly previous search pattern arrangement before shifting the center, wherein the center is shifted multiple times;
limiting the number of times the center may be shifted by at least one of:
a fixed number,
association with a permissible range or value of motion vector length, and
duration to check a refinement search pattern arrangement;
wherein the initial or refinement search pattern arrangement or both is a log arrangement with a maximum full arrangement comprising a diamond pattern at a step 1 with four candidate matching block location points, diamond patterns at steps 2, 4, 8, and 16 each with eight candidate matching block location points, and a diamond pattern forming sides of the diamond without corners at a step 32 and having 12 candidate matching block location points with three candidate matching block location points each on a diagonal side of the diamond shape, wherein the step is a unit distance from the center of the search pattern arrangement.

40. A computer-implemented system comprising:
a display;
a memory;
at least one processor communicatively coupled to the memory and display; and
a motion estimation unit operated by the at least one processor and being arranged to:
receive multiple frames of pixel data;
search to find a best motion vector by finding a best-matching block of pixel data on a reference frame located relative to a corresponding block on a current frame, the searching comprising:
determining a best matching block location (MBL) point of a plurality of candidate matching block location points of an initial search pattern arrangement at the reference frame;
locating a refinement search pattern arrangement at the best matching block location point;
testing candidate matching block location points of the refinement search pattern arrangement to determine a new best matching block location point, and
shifting the center of the refinement search pattern arrangement to the new best matching block location point without checking all of the candidate matching block location points included in the refinement search pattern arrangement.

41. The system of claim 40 wherein the processor(s) being arranged to:
form the refinement search pattern arrangement of a plurality of predefined sections; and
shift the center of the refinement search pattern arrangement after all of the matching block location points in a section have been tested.

42. The system of claim 41 wherein each section is a pattern, and wherein the refinement search arrangement is formed of:
a plurality of patterns,
the same pattern scaled to a plurality of different steps from the center wherein a step is a distance unit extending along a line from the center to a matching block location point in the pattern, or both,
wherein a pattern comprises a defined number of candidate matching block location points in a defined shape.

43. The system of claim 42 wherein a pattern extends in a ring around the center.

44. The system of claim 42 wherein the step is reduced to check a pattern closer to the center of the refinement search pattern arrangement when a new best matching block location point is not found on a current pattern.

45. The system of claim 42 where the processor(s) are arranged to set the maximum step of a pattern of the refinement search pattern arrangement extending about the shifted center to determine a refined best matching block location point, and to be the same step of the pattern having the best matching block location point of a directly previous search pattern arrangement before shifting the center.

46. The system of claim 40 wherein the center is shifted multiple times.

47. The system of claim 40 comprising limiting the number of times the center may be shifted by at least one of:
a fixed number,
association with a permissible range or value of motion vector length, and
duration to check a refinement search pattern arrangement.

48. The system of claim 40 wherein the motion estimation unit is arranged to:
form the refinement search pattern arrangement of a plurality of predefined sections; and
shift the center of the refinement search pattern arrangement after all of the matching block location points in a section have been tested, wherein each section is a pattern, and the refinement search arrangement is formed of:
a plurality of patterns,
the same pattern scaled to a plurality of different steps from the center wherein a step is a distance unit extending along a line from the center to a matching block location point in the pattern, or both,
wherein a pattern comprises a defined number of candidate matching block location points in a defined shape;
wherein a pattern extends in a ring around the center;
wherein the center is shifted when the new best matching block location point is found after checking one of:
at least one of the multiple candidate matching block location points on a pattern at a single step, and
after checking all of the multiple candidate matching block location points on a pattern at a single step;
the motion estimation unit arranged to:
reduce the step size to check candidate matching block location points on patterns increasingly closer to the center of the refinement search pattern arrangement;
decrease the step of the pattern to be checked while checking a first refinement search pattern arrangement directly after the checking of the initial search pattern arrangement, wherein the step is reduced to check a pattern closer to the center of the refinement search pattern arrangement when a new best matching block location point is not found on a current pattern;
set the maximum step of a pattern of the refinement search pattern arrangement extending about the shifted center to determine a refined best matching block location point, and to be the same step of the pattern having a best matching block location point of a directly previous search pattern arrangement before shifting the center, wherein the center is shifted multiple times;
limit the number of times the center may be shifted by at least one of:
a fixed number,
association with a permissible range or value of motion vector length, and
duration to check a refinement search pattern arrangement;
wherein the initial or refinement search pattern arrangement or both is a log arrangement with a maximum full arrangement comprising a diamond pattern at a step 1 with four candidate matching block location points, diamond patterns at steps 2, 4, 8, and 16 each with eight candidate matching block location points, and a diamond pattern forming sides of the diamond without corners at a step 32 and having 12 candidate matching block location points with three candidate matching block location points each on a diagonal side of the diamond shape, wherein the step is a unit distance from the center of the search pattern arrangement.

49. A computer-readable medium having stored thereon instructions that when executed cause a computing device to:
receive multiple frames of pixel data;
search to find a best motion vector by finding a best-matching block of pixel data on a reference frame located relative to a corresponding block on a current frame, the searching comprising:
determine a best matching block location point of a plurality of candidate matching block location points of an initial search pattern arrangement at the reference frame;
locate a refinement search pattern arrangement at the best matching block location point;
test candidate matching block location points of the refinement search pattern arrangement to determine a new best matching block location point, and
shift the center of the refinement search pattern arrangement to the new best matching block location point without checking all of the candidate matching block location points included in the refinement search pattern arrangement.

50. The computer-readable medium of claim 49 wherein the instructions cause the computing device to:
form the refinement search pattern arrangement of a plurality of predefined sections; and
shift the center of the refinement search pattern arrangement after all of the matching block location points in a section have been tested, wherein each section is a pattern, and the refinement search arrangement is formed of:
a plurality of patterns,
the same pattern scaled to a plurality of different steps from the center wherein a step is a distance unit extending along a line from the center to a matching block location point in the pattern, or both,
wherein a pattern comprises a defined number of candidate matching block location points in a defined shape;
wherein a pattern extends in a ring around the center;
wherein the center is shifted when the new best matching block location point is found after checking one of:
at least one of the multiple candidate matching block location points on a pattern at a single step, and
after checking all of the multiple candidate matching block location points on a pattern at a single step;
the instructions causing the computing device to:
reduce the step size to check candidate matching block location points on patterns increasingly closer to the center of the refinement search pattern arrangement;
decrease the step of the pattern to be checked while checking a first refinement search pattern arrangement directly after the checking of the initial search pattern arrangement, wherein the step is reduced to check a pattern closer to the center of the refinement search pattern arrangement when a new best matching block location point is not found on a current pattern;
set the maximum step of a pattern of the refinement search pattern arrangement extending about the shifted center to determine a refined best matching block location point, and to be the same step of the pattern having a best matching block location point of a directly previous search pattern arrangement before shifting the center, wherein the center is shifted multiple times;
limit the number of times the center may be shifted by at least one of:
a fixed number,
association with a permissible range or value of motion vector length, and
duration to check a refinement search pattern arrangement;
wherein the initial or refinement search pattern arrangement or both is a log arrangement with a maximum full arrangement comprising a diamond pattern at a step 1 with four candidate matching block location points, diamond patterns at steps 2, 4, 8, and 16 each with eight candidate matching block location points, and a diamond pattern forming sides of the diamond without corners at a step 32 and having 12 candidate matching block location points with three candidate matching block location points each on a diagonal side of the diamond shape, wherein the step is a unit distance from the center of the search pattern arrangement.
